(19) United States
(12) Patent Application Publication
(10) Pub. No.: US 2016/0367074 A1
(43) Pub. Date: Dec. 22, 2016

(54) CONTAINER FOR MICROWAVE OVEN COOKING

(71) Applicant: Chia Lin KAO, Taichung (TW)

(72) Inventor: Chia Lin KAO, Taichung (TW)

(21) Appl. No.: 14/740,346

(22) Filed: Jun. 16, 2015

(51) Int. Cl. A47J 36/02; A47J 36/06

(52) U.S. Cl. CPC A47J 36/027; A47J 36/06

(57) ABSTRACT

A container device includes a receptacle having a bottom wall and an outer peripheral wall for forming a chamber to engage with a heat conductive member, a housing is engaged into the receptacle and includes an inner peripheral flange, a cap is selectively engaged with the receptacle, and a cover is selectively engaged with an inner peripheral portion of the cap for selectively engaging onto the cap when the cap is engaged onto the receptacle, and the cover is engageable into the housing and engageable with the inner peripheral flange of the housing when the cap is disengaged from the receptacle for providing different food cooking effect to the microwave oven cooking.

### BACKGROUND OF THE INVENTION

### 1. Field of the Invention

The present invention relates to a container device for microwave oven cooking, and more particularly to a food container device including a cover engageable with the container device at different positions for providing different food cooking effect to the microwave oven cooking.

### 2. Description of the Prior Art

Various kinds of typical container devices have been developed and provided for conducting food cooking operation, and/or for convenient and easy heating of food and drink, and normally comprise a container for containing the food and drink, and a cover engageable onto the container device for covering and retaining the food and drink within the container device.

For example, U.S. Pat. No. 6,229,131 to Koochaki, U.S. Pat. No. 6,609,627 to Clarke, U.S. Pat. No. 7,090,090 to Ohyama, U.S. Pat. No. 7,109,455 to Hopkins, Sr., U.S. Pat. No. 7,671,308 to Kreisman et al., U.S. Pat. No. 8,367,989 to Pralus, U.S. Pat. No. 8,497,455 to Hodson et al., U.S. Pat. No. 8,558,149 to Huber et al., and U.S. Pat. No. 8,592,736 to DiLonardo et al. disclose several of the typical container devices for microwave oven cooking and each also comprising a container or receptacle for receiving the food and drink, and a cover engageable onto the receptacle for covering and retaining the food and drink within the container device and for preventing the food and drink from being disengaged or flown out of the receptacle.

However, the typical container devices for microwave oven cooking may only be provided for receiving or containing the food and drink as a stock pot or stuffy port or the like, and may not be used with the other purposes, for example, the typical container devices may not be used as frying pans, roast fryers, roast pots, roasters, fryers et al., skillets, or the like.

The present invention has arisen to mitigate and/or obviate the afore-described disadvantages of the conventional container devices for microwave oven cooking.

### SUMMARY OF THE INVENTION

The primary objective of the present invention is to provide a container device for microwave oven cooking including a food container device including a cover engageable with the container device at different positions for providing different food cooking effect to the microwave oven cooking.

In accordance with one aspect of the invention, there is provided a container device comprising a receptacle including a bottom wall and an outer peripheral wall for forming a chamber in the receptacle, a heat conductive member engaged in the chamber of the receptacle, a housing engaged into the chamber of the receptacle, and including a compartment formed in the housing and defined by a bottom panel and an outer peripheral panel, and the housing including an inner peripheral flange formed therein, a cap including an outer peripheral portion for selectively engaging with the receptacle and for allowing the cap to be selectively engaged onto the receptacle, the cap including an inner peripheral portion, and a cover including an outer peripheral portion for selectively engaging with the inner peripheral portion of the cap and for selectively engaging onto the cap when the cap is engaged onto the receptacle, and the outer peripheral portion of the cover being engageable with the inner peripheral flange of the housing for engaging into the compartment of the housing when the cap is disengaged from the receptacle.

The cover includes a space formed therein, a lid attached to a bottom portion of the cover for enclosing the space of the cover, a heat conductive element engaged into the space of the cover and engaged onto the lid. The lid includes one or more protrusions extended downwardly therefrom.

The cover includes a heat insulated element engaged into the space of the cover and engaged with the heat conductive element. The cover includes one or more orifices formed therein and communicating with the space of the cover for allowing an air in the space of the cover to flow out of the cover.

The lid includes an outer peripheral portion having an outer diameter smaller than that of the outer peripheral panel of the housing for preventing the lid from being contacted with the housing when the cover is engaged into the compartment of the housing.

The lid includes an outer peripheral flap extended upwardly from the outer peripheral portion of the lid for engaging with the cover and for securing the lid to the cover. The outer peripheral flap of the lid is spaced from the outer peripheral panel of the housing for 8 mm.

The receptacle includes an inner peripheral slot formed in an upper portion of the peripheral wall and communicating with the chamber of the receptacle, and the housing includes a peripheral rib extended from an upper portion of the housing for engaging with the peripheral slot of the peripheral wall of the receptacle and for anchoring the housing to the receptacle.

The housing includes a swelling extended upwardly from the bottom panel and into the compartment of the housing for forming a depression within the swelling and for engaging with the heat conductive member. The housing includes a peripheral recess formed around the swelling for collecting fluid.

The receptacle includes one or more passages formed therein and communicating with the chamber of the receptacle for allowing an air in the chamber of the receptacle to flow out of the receptacle.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a container device in accordance with the present invention;

FIG. 2 is a perspective view of the container device;

FIG. 3 is a cross sectional view of the container device taken along lines 3-3 of FIG. 2;

FIG. 4 is an enlarged partial cross sectional view of the container device; and

FIG. 5 is a cross sectional view similar to FIG. 3, illustrating the operation of the container device,

### DETAILED DESCRIPTION OF THE PREFERRED EMBODIMENT

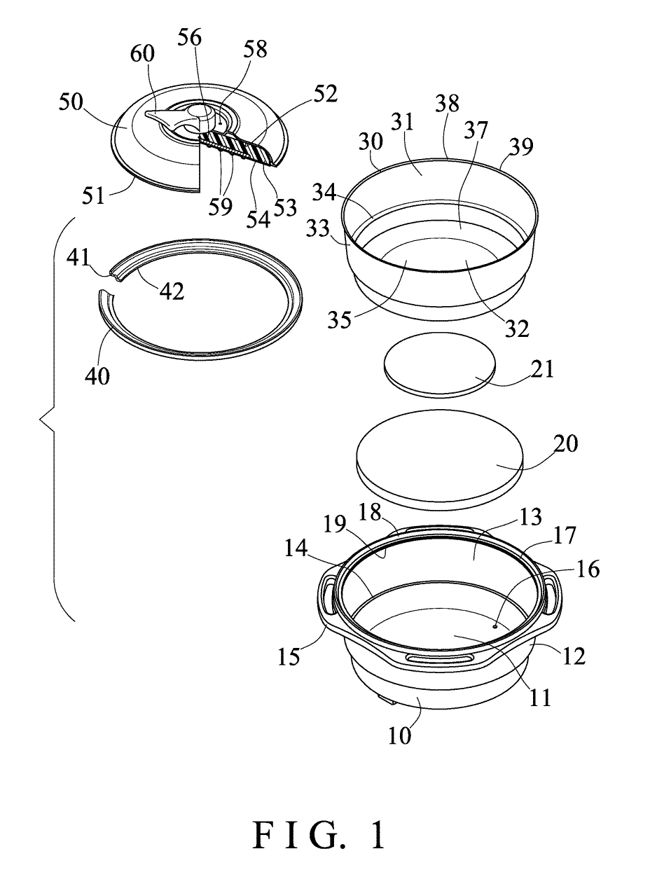

Referring to the drawings, and initially to FIGS. 1-4, a container device in accordance with the present invention comprises a container main body or outer receptacle 10 including a bottom wall 11, and an outer peripheral wall 12 for forming or defining an inner compartment or chamber 13 therein, and including a peripheral shoulder 14 formed or provided in the middle or intermediate portion of the outer peripheral wall 12, and including one or more (such as four) ears or hand grips 15 formed or provided on the outer peripheral portion of the peripheral wall 12 for being grasped or held by the user or the like. The receptacle 10 further includes one or more air passages 16 formed or provided in the bottom wall 11 and communicating with the inner chamber 13 of the receptacle 10 for allowing the air contained in the inner chamber 13 of the receptacle 10 to selectively flow out of the receptacle 10 and for preventing the chamber 13 of the receptacle 10 from being over-pressurized.

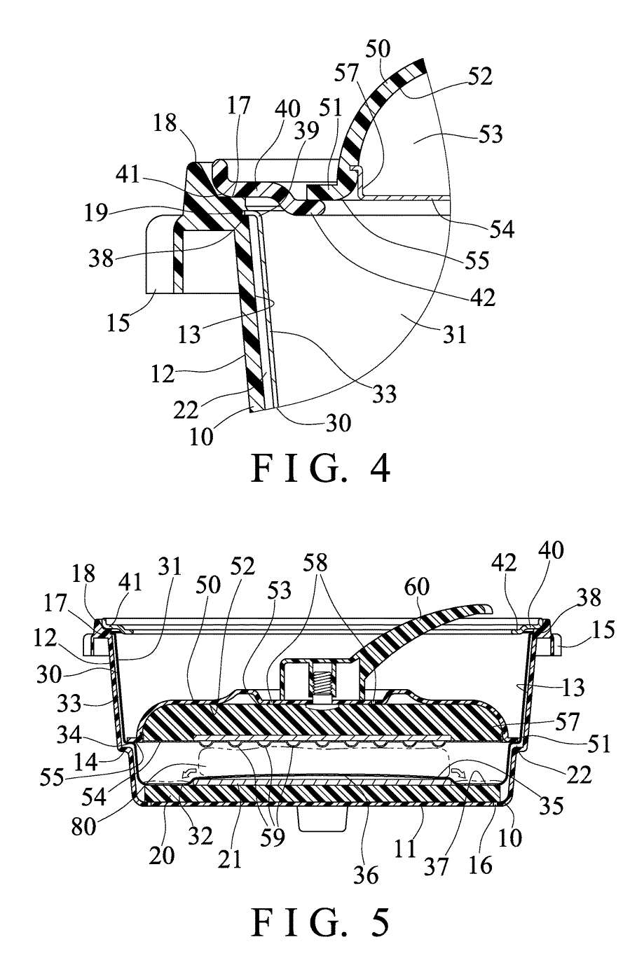

The receptacle 10 is preferably made of selected materials, such as glass, heat resistant plastic materials, or the like that may be used and worked within the microwave oven, and may further include a peripheral seat 17 formed or provided on the upper portion 18 of the peripheral wall 12 and faced or directed upwardly relative to the peripheral wall 12, and an inner peripheral recess or slot 19 (FIG. 4) also formed or provided on the upper portion 18 of the peripheral wall 12 and faced or directed inwardly and communicating with the inner chamber 13 of the receptacle 10. A heat insulated member 20 is disposed or engaged into the inner chamber 13 of the receptacle 10, and a heat conductive member 21 is also disposed or engaged into the inner chamber 13 of the receptacle 10, and made of china or porcelain materials having conductive aluminum powder and/or carbon powder engaged therein, and engaged onto the heat insulated member 20.

An inner receptacle or housing 30 is to be disposed or engaged into the inner chamber 13 of the receptacle 10, and made of metal or heat conductive materials, and includes an inner chamber or compartment 31 formed therein and formed or defined by a bottom panel 32 and an outer peripheral panel 33, and includes an inner peripheral flange 34 formed or provided therein and located close to or faced or directed toward the peripheral shoulder 14 of the receptacle 10, and includes a swelling 35 extended upwardly from the bottom panel 32 and into the compartment 31 of the housing 30, for forming or defining a depression 36 within the lower or inner portion of the swelling 35 and for receiving or engaging with the heat conductive member 21 (FIGS. 3, 5), and for forming or defining a peripheral recess 37 around the swelling 35 and for collecting grease or fluid within the peripheral recess 37 while cooking.

As shown in FIGS. 3 and 5, the bottom panel 32 of the housing 30 is contacted or engaged with the heat insulated member 20, and the inner peripheral flange 34 of the housing 30 is not necessarily contacted or engaged with the peripheral shoulder 14 of the receptacle 10, i.e., the housing 30 is spaced or separated from the receptacle 10 for forming or defining a space or gap 22 between the housing 30 and the receptacle 10 and for air circulating purposes. The housing 30 further includes a peripheral rib 38 extended radially and outwardly from the upper portion 39 thereof (FIG. 4) for engaging with or into the peripheral slot 19 of the peripheral wall 12 of the receptacle 10 and for anchoring or retaining or positioning the housing 30 to the receptacle 10 and for preventing the housing 30 from being moved or disengaged or separated from the receptacle 10.

A lid or cap 40 includes a peripheral or ring shaped having an outer peripheral portion 41 for selectively or optionally contacting or engaging with the peripheral seat 17 of the receptacle 10 and for allowing the cap 40 to be selectively or optionally engaged or disposed or attached or mounted onto the upper portion 18 of the peripheral wall 12 of the receptacle 10. The cap 40 includes an inner peripheral portion 42 extended radially and inwardly into the compartment 31 of the housing 30 and located above the housing 30, and/or the inner peripheral portion 42 of the cap 40 includes an inner diameter smaller than that of the receptacle 10 and the housing 30. The cap 40 is preferably made of selected materials, such as glass, heat resistant plastic materials, or the like that may be used and worked within the microwave oven.

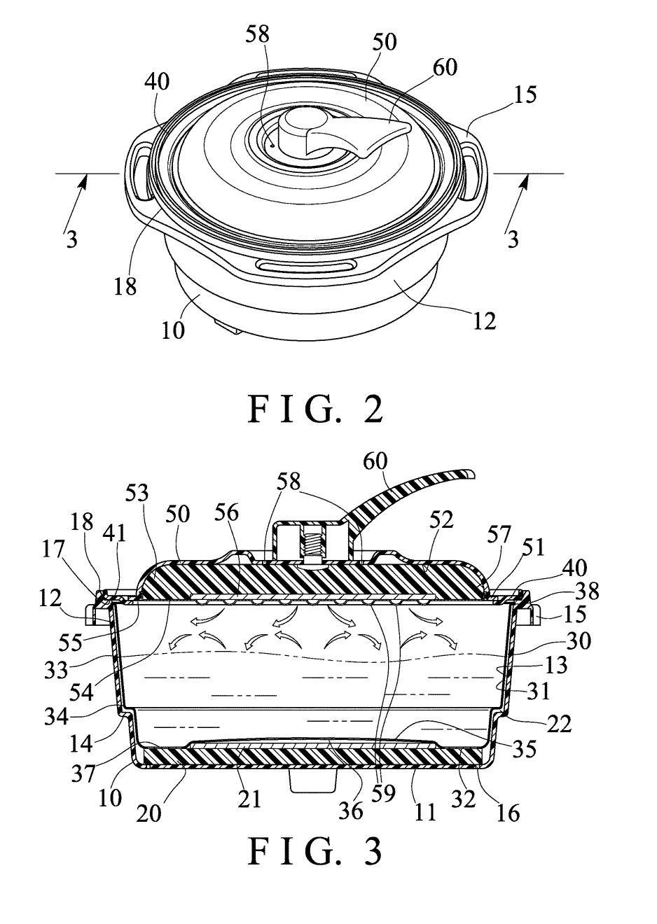

A cover 50 includes an outer peripheral portion 51 for selectively contacting or engaging with the inner peripheral portion 42 of the cap 40 (FIGS. 2, 3, 4) and for selectively attaching or engaging onto the cap 40; and the outer peripheral portion 51 of the cover 50 may also be provided for selectively contacting or engaging with the inner peripheral flange 34 of the housing 30 (FIG. 5) and for selectively engaging into the compartment 31 of the housing 30. The cover 50 includes a space 52 formed therein for receiving or engaging with a heat insulated element 53, and a heat conductive cap or lid 54 attached or mounted or secured to the lower or bottom portion 55 of the cover 50 for enclosing the space 52 of the cover 50 and for contacting or engaging with the heat insulated element 53, and thus for anchoring or retaining or positioning the heat insulated element 53 within the space 52 of the cover 50.

A heat conductive element 56 is also disposed or engaged into the space 52 of the cover 50, and made of china or porcelain materials having conductive aluminum powder and/or carbon powder engaged therein, and engaged onto or into the lower or bottom portion of the heat insulated element 53, or the heat conductive element 56 is disposed or engaged between the heat insulated element 53 and the lid 54, or engaged onto the lid 54. It is preferable that the heat conductive lid 54 includes an outer peripheral ear or flap 57 folded or extended upwardly from the outer peripheral portion thereof (FIGS. 3-5) for engaging with the cover 50 and for securing the lid 54 to the cover 50. As shown in FIG. 5, the outer peripheral flap 57 and/or the outer peripheral portion of the lid 54 includes an outer diameter smaller than that of the outer peripheral panel 33 of the housing 30, and also smaller than the inner diameter of the inner peripheral flange 34 of the housing 30 for preventing the conductive lid 54 from being contacted or engaged with the conductive housing 30, and the space or distance between the outer peripheral flap 57 and/or the outer peripheral portion of the lid 54 and the outer peripheral panel 33 or the inner peripheral flange 34 of the housing 30 is arranged about 8 mm.

The cover 50 includes one or more air orifices 58 formed or provided therein and communicating with the inner space 52 of the cover 50 for allowing the air contained in the inner space 52 of the cover 50 to selectively flow out of the cover 50 and for preventing the space 52 of the cover 50 from being over-pressurized. The lid 54 preferably includes one or more bulges or protrusions 59 extended downwardly therefrom for selectively contacting or engaging with the meat or food 80 (FIG. 5) to be cooked with cooked with the microwave oven and for solidly and stably anchoring or retaining or positioning the food 80 in place. The cover 50 may include a handle 60 extended upwardly therefrom or attached or mounted or secured thereto for carrying or handling the cover 50.

In operation, as shown in FIGS. 2-4, the cap 40 may be selectively or optionally engaged or disposed or attached or mounted onto the upper portion 18 of the peripheral wall 12 of the receptacle 10, and the cover 50 may be selectively or optionally engaged onto the cap 40 for allowing the container device to be used and worked as a skillet, stock pot or stuffy port or the like. As shown in FIG. 5, the cap 40 may be selectively or optionally disengaged or removed from the receptacle 10 and the housing 30, and the cover 50 may be selectively or optionally engaged onto the inner peripheral flange 34 of the housing 30 for selectively engaging into the compartment 31 of the housing 30, and for allowing the container device to be used and worked as a frying pan, roast fryer, roast pot, roaster, fryer or the like.

Accordingly, the container device for microwave oven cooking in accordance with the present invention includes a food container device including a cover engageable with the container device at different positions for providing different food cooking effect to the microwave oven cooking.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A container device comprising:
a receptacle including a bottom wall and an outer peripheral wall for forming a chamber in said receptacle,
a heat conductive member engaged in said chamber of said receptacle,
a housing engaged into said chamber of said receptacle, and including a compartment formed in said housing and defined by a bottom panel and an outer peripheral panel, and said housing including an inner peripheral flange formed therein,
a cap including an outer peripheral portion for selectively engaging with said receptacle and for allowing said cap to be selectively engaged onto said receptacle, said cap including an inner peripheral portion, and
a cover including an outer peripheral portion for selectively engaging with said inner peripheral portion of said cap and for selectively engaging onto said cap when said cap is engaged onto said receptacle, and said outer peripheral portion of said cover being engageable with said inner peripheral flange of said housing for engaging into said compartment of said housing when said cap is disengaged from said receptacle.

2. The container device as claimed in claim 1, wherein said cover includes a space formed therein, a lid attached to a bottom portion of said cover for enclosing said space of said cover, a heat conductive element engaged into said space of said cover and engaged onto said lid.

3. The container device as claimed in claim 2, wherein said cover includes a heat insulated element engaged into said space of said cover and engaged with said heat conductive element.

4. The container device as claimed in claim 2, wherein said cover includes at least one orifice formed therein and communicating with said space of said cover for allowing an air in said space of said cover to flow out of said cover.

5. The container device as claimed in claim 2, wherein said lid includes at least one protrusion extended downwardly therefrom.

6. The container device as claimed in claim 1, wherein said lid includes an outer peripheral portion having an outer diameter smaller than that of said outer peripheral panel of said housing for preventing said lid from being contacted with said housing when said cover is engaged into said compartment of said housing.

7. The container device as claimed in claim 6, wherein said lid includes an outer peripheral flap extended upwardly from said outer peripheral portion of said lid for engaging with said cover and for securing said lid to said cover.

8. The container device as claimed in claim 6, wherein said outer peripheral portion of said lid is spaced from said inner peripheral flange of said housing.

9. The container device as claimed in claim 8, wherein said outer peripheral portion of said lid is spaced from said inner peripheral flange of said housing for 8 mm.

10. The container device as claimed in claim 1, wherein said receptacle includes an inner peripheral slot formed in an upper portion of said peripheral wall and communicating with said chamber of said receptacle, and said housing includes a peripheral rib extended from an upper portion of said housing for engaging with said peripheral slot of said peripheral wall of said receptacle and for anchoring said housing to said receptacle.

11. The container device as claimed in claim 1, wherein said housing includes a swelling extended upwardly from said bottom panel and into said compartment of said housing for forming a depression within said swelling and for engaging with said heat conductive member.

12. The container device as claimed in claim 11, wherein said housing includes a peripheral recess formed around said swelling for collecting fluid.

13. The container device as claimed in claim 1, wherein said receptacle includes at least one passage formed therein and communicating with said chamber of said receptacle for allowing an air in said chamber of said receptacle to flow out of said receptacle.
